(19) United States
(12) Patent Application Publication
(10) Pub. No.: US 2004/0244683 A1
(43) Pub. Date: Dec. 9, 2004

(54) Fixture for holding a vehicle body part

(76) Inventor: Volker Beckord, Hannover (DE)

Correspondence Address: Patrick W Rasche, Armstrong Teasdale, One Metropolitan Square, Suite 2600, St. Louis, MO, 63102, US

(21) Appl. No.: 10/482,618

(22) PCT Filed: Jun. 29, 2001
(86) PCT No.: PCT/EP01/07499

(51) Int. Cl. B05C 13/00; B05C 13/02

(52) U.S. Cl. 118/500; 118/503

(57) ABSTRACT

A processing means (10; 20; 30) is disclosed, with which to hold part of a vehicle body (1; 6) during a processing operation in vehicle construction, in particular painting. With the objective of disclosing an improved, distinctly more economical and easily manipulated processing means of this kind, it is designed as a plastic holder with two contact or engagement sections (14; 19a; 22; 23; 33; 34; 35) disposed near its ends, which are to be inserted between two body parts (1; 2; 6) in order to fix them at a prespecified distance from one another.

The invention relates to a processing means for vehicle construction according to the precharacterizing clause of claim 1.

Processing means of the kind concerned here, also called production accessories, have the function of keeping add-on parts, such as doors and the covers for luggage and engine compartments, at a specified distance from the basic body of the vehicle, in order to prevent these add-on parts from touching or impacting against the basic body during manufacture, e.g. during the painting operation. These processing means or spacer devices are employed after the body itself has been assembled and before passage through the pretreatment stages, which consist of degreasing, rinsing, phosphatizing and cathodal electrophoresis plus dip priming (herinafter termed CDP). After the CDP coating has been heat-cured at temperatures up to 220° C. in a forced-air oven, the primed body is ready for the final paint application.

These processing means are constructed specifically for the particular area of application and model of vehicle concerned, and at present are made of steel and intended to be usable in various ways. Specially and elaborately configured fixation and/or engagement sections are provided to make contact with the basic body on one hand and the add-on parts on the other hand, so as to avoid damage to the vulnerable surfaces. In view of this situation, and because of the material employed, the known processing means are relatively expensive.

Because these holding devices are also coated during the painting process, every time they are used or pass through the processing sequence they must have this paint removed, whether mechanically, thermally or chemically, which involves high costs. This measure is necessary in order to avoid contamination of the newly coated or painted body surface by fragments of paint that might otherwise flake off the processing means during the required manipulations, such as opening the add-on parts so that installations in the interior of the vehicle can be carried out.

For paint removal, the following steps are required. After the processing means have been disassembled (removed) they must be sorted according to type. Because during the painting process the movable parts of the processing means, such as screws, brackets etc., lose their mobility and hence become nonfunctional, their mobility must be manually restored. After paint removal it is necessary first to test whether any paint residues are still present on the processing means, and then to determine whether the objects have been bent out of shape so that they are no longer usable. If the quality requirements have not been fulfilled, the processing means must again be passed through the paint-removal process, after type-sorting, or be repaired.

A multiple utilization of the fixation elements can be achieved only by labor- and cost-intensive subsequent treatment after use, and even then there is always a residual risk regarding their quality, and it remains possible that while a vehicle is proceeding along the assembly line it will need to be refinished, imposing additional costs.

The entire paint-removal operation must thus be performed by either the subcontractor or the manufacturer of the vehicle, although it is not in principle the responsibility of either of these, and is uneconomical for them. Resources such as space, personnel (workers), management and the like must be provided, and hence are not available for other tasks. On the other hand, performance of these tasks at source (by the manufacturer of the processing means), at least in the workshops of origin, is ruled out by the excessive cost and effort of transport and the enormous stocks of these processing means that would have to be available. Furthermore, the effort involved in paint removal is costly in any case—regardless of who must bear the expense.

Another consideration, apart from the expense, is that paint removal is not useful regarding the overall ecological balance, because removal of a coating necessarily involves large emissions of waste gases and produces residues potentially harmful to the environment.

Finally, manipulation of the known precision processing means made of steel requires some training and great care, which necessitates the employment of qualified and highly paid workers, or else the installation of robots designed to operate with high precision.

It is thus the objective of the present invention to disclose an improved, distinctly more economical and easily handled processing means of the generic kind.

The invention includes the fundamental idea that the processing means in question are made not of steel (or another metal, e.g. aluminium or brass) but rather, in an extremely simple and economical way, of plastic. This radical departure from customary practice enables a dramatic reduction of the manufacturing costs, because there is less expenditure for materials and processing, and also results in processing means that weigh considerably less and because of their lower weight and their elasticity are considerably easier (even for semiskilled workers) to manipulate; furthermore, the properties of the new material make it easier, in some cases decisively so, for the paint removal described above to be performed in preparation for subsequent use.

An essential point of the invention resides in the fact that a processing means need not, as has customarily been the case, be constructed very precisely to match the specific shape of a vehicle body at the site where it is to be attached. Instead, for instance, now the holes provided for fixing the door attachments (e.g., by screws or rivets) can be used to mount a processing means of the kind concerned here. That is, wherever such a door attachment is eventually to be connected, the processing means can be mounted by inserting appropriate connectors, e.g. screws etc. In the case of a screw connection, in particular, it is advantageous that entry of paint into the threaded hole during passage through an immersion bath is avoided.

However, an especially advantageous aspect here is that when this processing means is used, it is practically impossible for it to damage the paint at places that will later be visible, i.e. are not covered by a door attachment. It is thus possible to avoid major efforts to repair damaged paint spots, which otherwise regularly delay the delivery of vehicles to customers.

Following intensive practical trials suitable plastics have been found, namely plastics that have the required characteristics and that can be employed for injection moulding. For this purpose thermally stable plastics are preferred, which tolerate a long-term working temperature above 170° C.; these include, e.g., polysulfone, poly(arylether)ketone, poly(ethersulfone), ABS (acrylonitrile/butadiene/styrol), but especially polyamides.

Particularly suitable are plastics reinforced with fibres made, e.g., of glass, carbon, kevlar or the like. A material that has proved especially suitable regarding purchase costs, recyclability, injection moulding (optimal flow behaviour) and mechanical properties, even at temperatures as high as those in the burning-in oven, is glass-fibre-reinforced polyamide. The elasticity of shape of the above-mentioned plastics and the bending characteristics of structurally suitable holders, extension arms and engagement sections made of these materials enable them to be easily inserted into the openings provided for that purpose in the add-on parts and in the basic body of the vehicle, so that the danger of damaging adjacent surfaces is decisively less than in the case of the known hard and inflexible, or only slightly flexible, metal processing means.

The advantages set forth above can be demonstrated in particular when the plastics are reinforced by fillers in the ratio of 0.1 to 40%. Within this range of filler content, depending on the requirements regarding good flow behaviour during injection moulding and an aoorioruate shape stability and firmness of the processing means during the painting operation, a desirable optimum can be achieved.

A quite substantial advantage resides in the degree of adherence of the paint to glass-fibre-reinforced polyamide (and others of the above-mentioned plastics) in modern systems for vehicle painting; in comparison to metal, these materials are stabler and less sensitive to impacts, so that there is less likelihood that the paint will flake off, which in turn reduces the risk of contamination of the freshly coated body surface.

The processing means in accordance with the invention are in particular first produced by the injection-moulding procedure and then, once they have been used or at least after they have been used for a limited number of times, are ground up while still in the painted state; new processing means can then be produced directly from the resulting powder.

Hence when the plastics in accordance with the invention are employed, the whole processing sequence is simplified. After the processing means have been used, there is no longer any need to sort them according to type, because the processing means are disposable parts and amount to bulk material that can be supplied for injection moulding. A particular consequence is that there are no costs for handling or for the restoration of functionality that would otherwise sometimes be necessary. The processing means produced in this way also provide considerable advantages regarding the overall ecological balance, because the use of chemicals for paint removal is eliminated or at least reduced.

The manufacture and employment of the proposed processing means last mentioned above also provides considerable advantages regarding factory organization and economics, because the vehicle manufacturer (i.e., the user) has no responsibility for ensuring that these means are in a state such that they can be re-used, or at least substantially less responsibility than is the case for the known processing means.

During injection moulding in a recycling system it is advantageous for a certain amount—preferably about 5-30%, in particular 10%—of the original raw material to be added. This can be useful in particular if the quality of the paint-contaminated plastic recycling material is no longer satisfactory. By addition of the original raw material the functionality of the processing means can be maintained, with the advantages cited above.

The contact or engagement sections of the proposed plastic processing means are of course constructed so as to be adapted to the body configuration of the particular vehicle concerned and the specific design of the door-locking regions, lock reinforcements etc. of the add-on components; however, they match one another with respect to the elasticity of the plastic material selected and of their shape. The result is that they are easily handled, even by semiskilled workers, with no danger of damage to the adjacent surfaces. The above-mentioned shape elasticity is implemented, for example, by suitably dimensioned and oriented edging, hook, spring or spiral elements. The degree of shape elasticity is determined along with the selection of the basic plastic material, by choosing a suitable filling material or a fibre reinforcement and by the proportion thereof that is chosen.

The installation of plastic holders between the body and add-on parts that are to be spaced apart from one another, and the removal of the add-ons after the manufacturing process (in particular, painting), are likewise facilitated by the flexural elasticity of the rods, extension arms, plates and the like that make up the basic structure of the plastic holder. The above-mentioned fibre-reinforced plastics make it easily possible to design the holders so that they have the desired flexibility.

The proposed materials just as easily enable the holders to be moulded with suitably shaped handling sections, which allow installation by robots in that they are adapted to the gripping tools of the robots. It applies in principle also to robot assembly that the advantages for manipulation provided by the material mean that the demands for precision in the movement sequences are less severe, which enables more economical solutions to be derived.

Further advantages and useful features of the invention will be apparent from the subordinate claims and from the following description of preferred exemplary embodiments with reference to the attached drawings, wherein

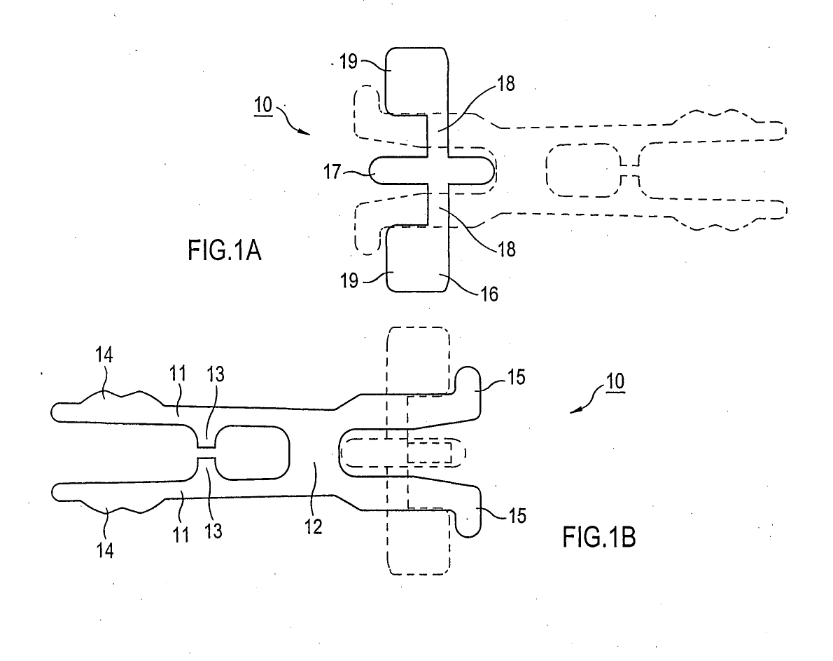

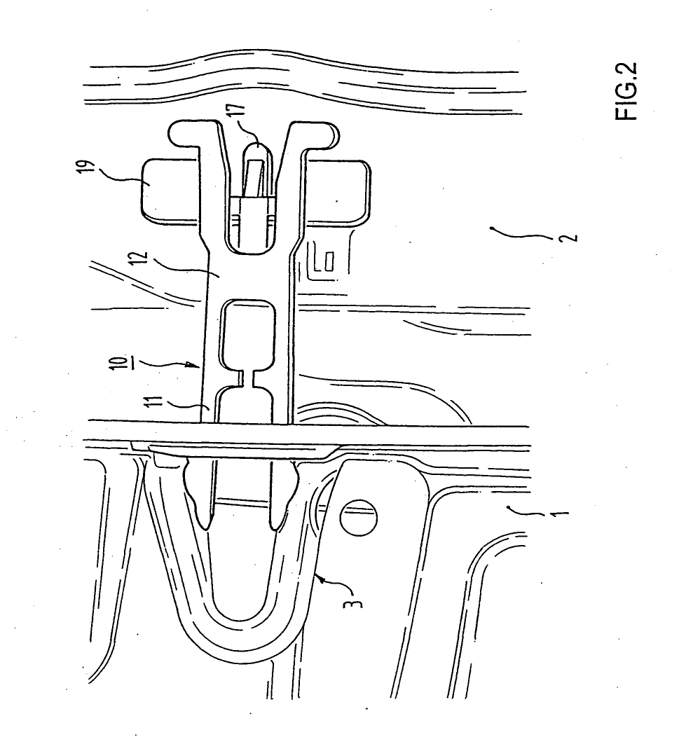

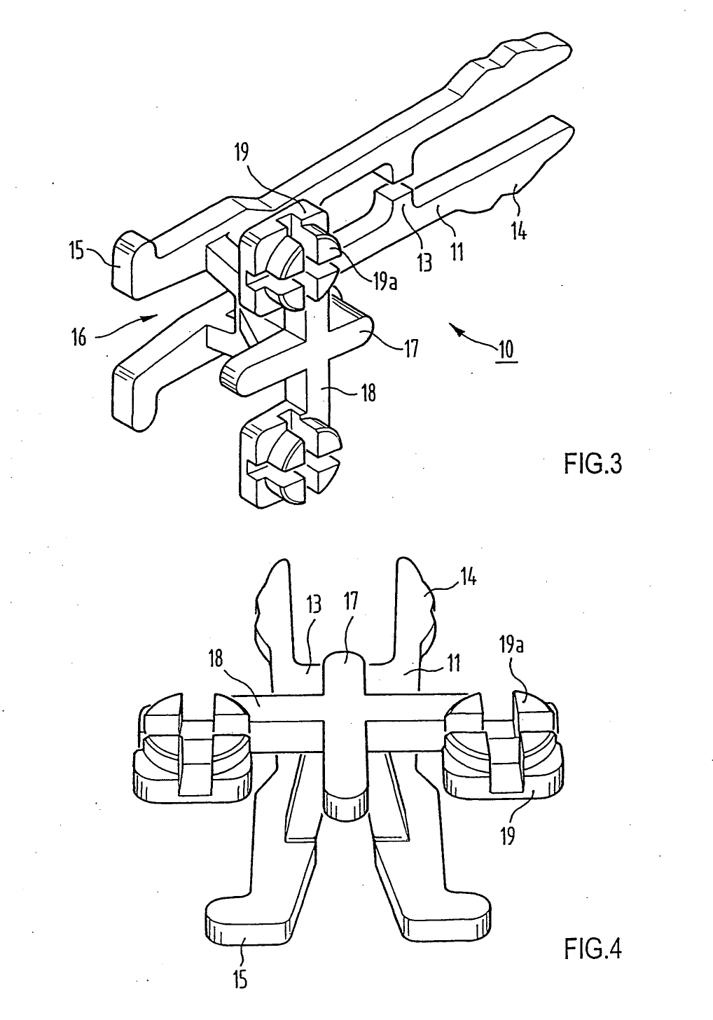

FIGS. 1A to 4 are various representations of a door hook, as a first embodiment of the processing means in accordance with the invention; FIGS. 1A and 1B show partial views from below and above, respectively, while FIG. 2 shows the mounting on a vehicle body and FIGS. 3 and 4 show two perspective views.

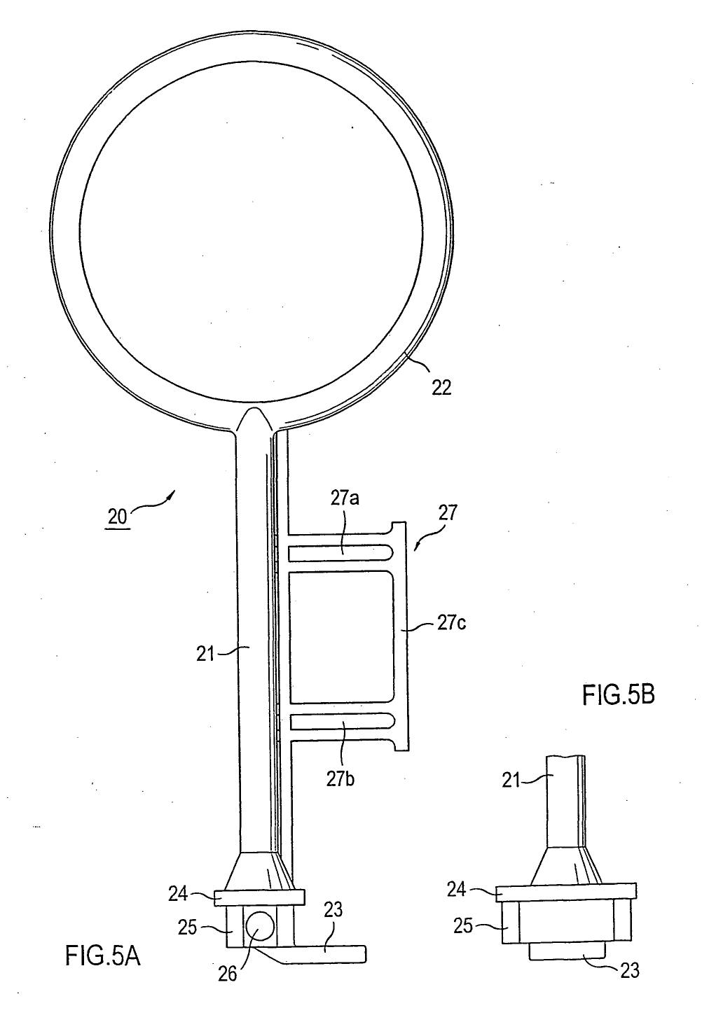

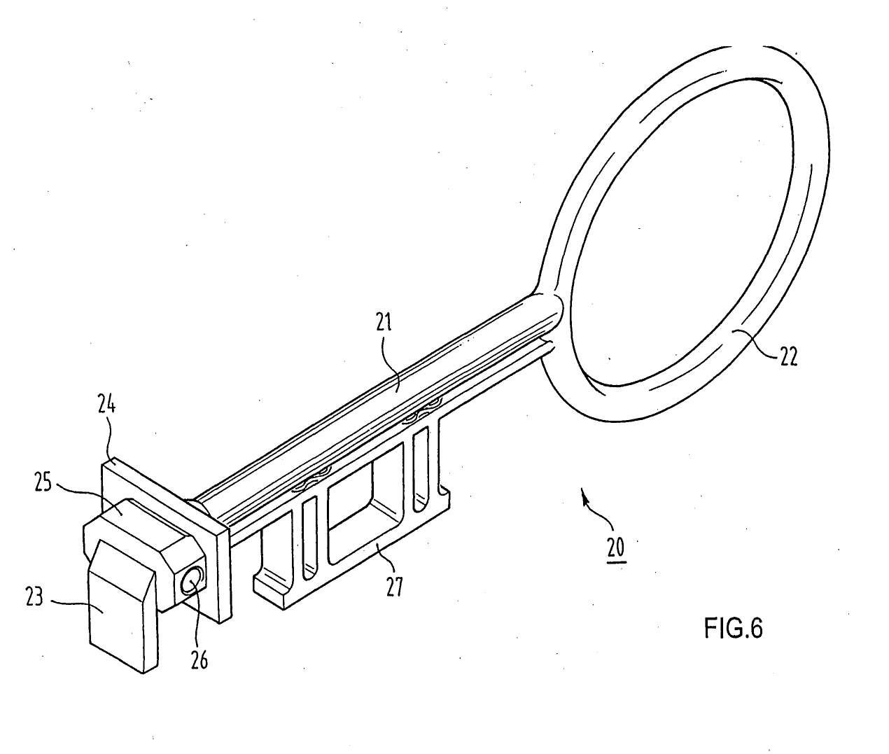

FIGS. 5A to 6 show a side view (FIG. 5A), a detail thereof in plan view (FIG. 5B) and a perspective drawing (FIG. 6) of a cover hook as another embodiment of the processing means in accordance with the invention, and

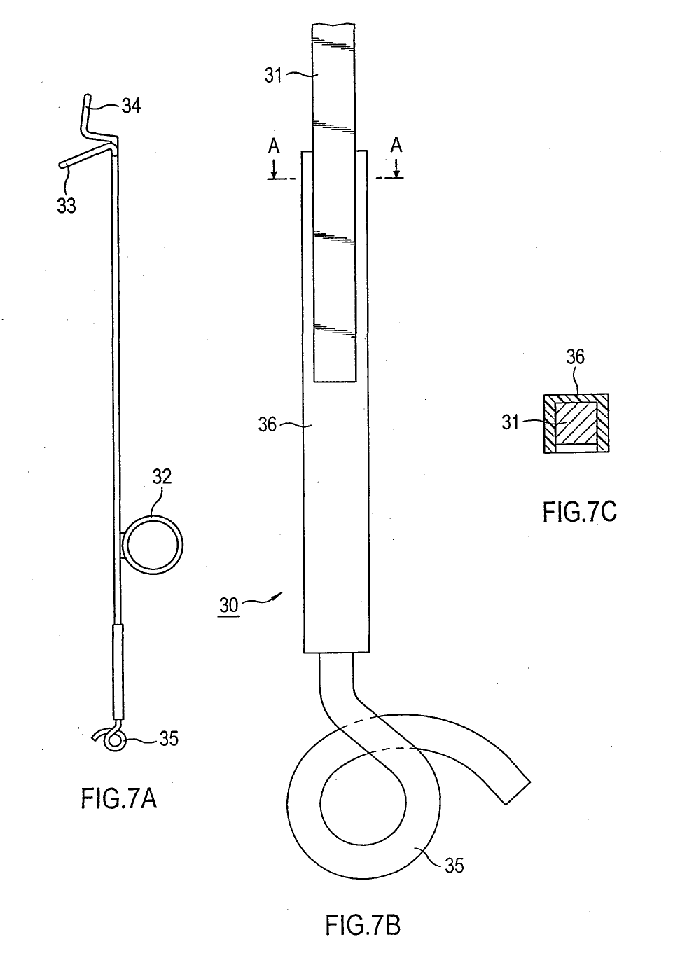

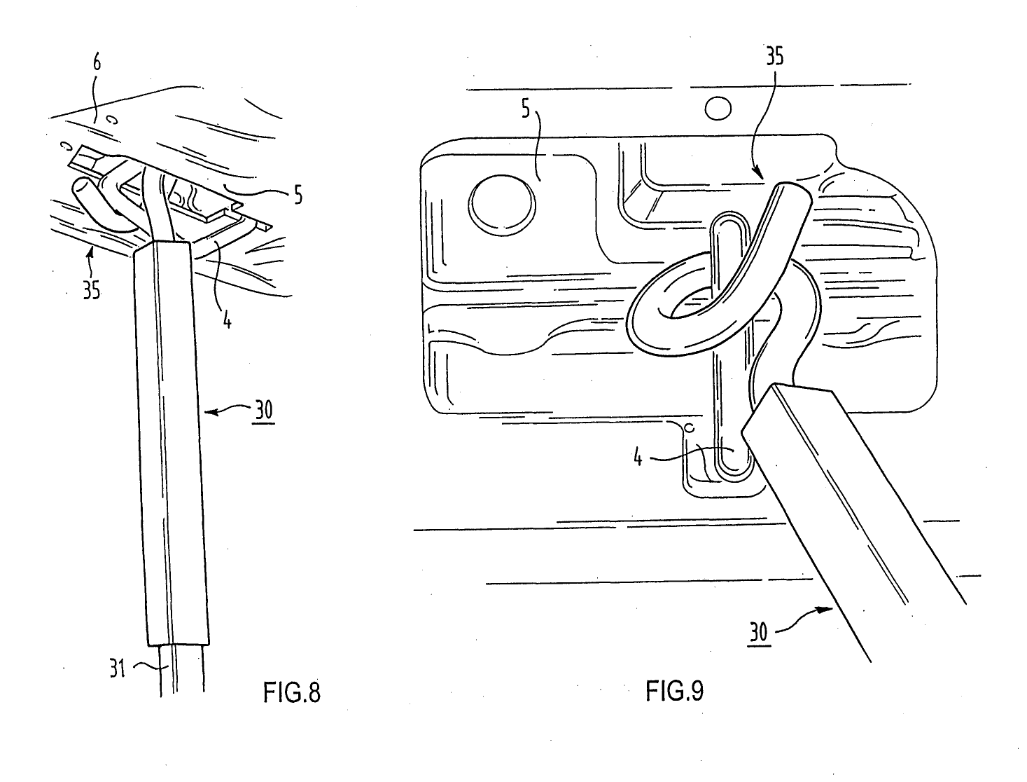

FIGS. 7A to 9 are various representations of a prop for a bonnet (hood) as a further embodiment of the processing means in accordance with the invention: FIG. 7A is a side view, FIG. 7B is an enlarged detail (also in side view), FIG. 7C shows a cross section along the line A-A in FIG. 7B, and FIGS. 8 and 9 are perspective views to explain the installation situation.

In the following, the plastic holder 10 shown in FIGS. 1A to 4 is designated a door hook; its purpose is to keep a vehicle door 1 open at a prespecified distance from the B-post 2, so that it is positioned at a prespecified angle with respect to the basic body of the vehicle. The door hook 10 comprises two arms 11 that extend within a plane so that they are nearly parallel to one another, diverging by only a slight angle; they are connected at a point somewhat off-center by a connecting piece 12 (bridge), and at some distance from the connecting piece 12 a spacer projection 13 extends from each of them towards the other arm.

At the one end of the arms 11 are provided externally disposed, barb-like expansions 14, which serve as first catch sections by engaging a locking region 3 in a metal plate within the vehicle door 1 (FIG. 2). The opposite ends 15 of the arms 11 are bent outward in a hook shape. Near these hook-shaped ends 15 the arms 11 are connected to an attachment plate 16 (in particular one that is made integral with the arms 11 during casting), which in the assembled state (FIG. 2) lies below the plane of the arms 11. The attachment plate 11 consists of an elongated central part 17 and, extending symmetrically therefrom, two arms 18 with thickened ends 19.

At these ends are situated—as can best be seen in FIGS. 3 and 4—mounting pegs 19a, which are subdivided by crosswise slits and hence are particularly elastic, and which are to be inserted into two correspondings opening in the B-post 2. When the mounting pegs 19a are inserted into these openings, the hook 10 is fixed to the B-post. They constitute second engagement sections of the door hook. As can be seen in FIG. 2, the free ends of the arms 11, which bear the expansions 14 and are flexurally elastic, engage the internal plate in the locking region 3 of the vehicle door 1 so that, because of the elasticity in both shape and material of the engagement sections 14 and the arms 1 as a whole, the door is not rigidly but nevertheless permanently kept at a distance from the basic body of the vehicle.

The configuration of the central sections of the arms 11 shown here, with the stable connecting piece 12 and the spacer projections 13 that can be moved toward one another, constitutes an engagement section for a gripping tool of a robotic manipulator, so that when the painting process has been completed, the door hook 10 that has been inserted between B-post and door can be removed by such a robot without being broken.

FIGS. 5A to 6 show a cover hook 20 to keep open the cover of the luggage compartment of a passenger vehicle during a manufacturing process (in particular painting). The cover hook 20 consists of a basically rectangular, fluted structure (rod) 21, which at one end terminates in a holder ring 22 in the same plane as the rod 21 and at the other end is expanded and flattened to form a hook 23, which constitutes an engagement section to engage a lock-reinforcing structure in the luggage-compartment cover.

The hook 23 is separated from the rod 21 by a substantially rectangular supporting flange 24, which extends in a plane perpendicular to that of the rod 21 and the holder 22. The supporting flange 24 bears an elongated thickening 25 through which passes a bore 26 oriented parallel to the plane of the supporting flange 24.

The middle region of the basic structure 21 is shaped so as to comprise a substantially rectangular but specially configured holding frame 27. This consists of two pairs of projections 27a, 27b, which in cross section form flat rectangles and extend perpendicularly from the rod 21 at a slight distance from one another, as well as a bridge 27c, which connects the projection pairs and is likewise a flat rectangle in cross section. The holding frame 27 serves as a handle to be used when installing and removing the cover hook 20, and by way of the holder ring 22 the hook is inserted into correspondingly arranged hooks on the cover of the luggage compartment.

FIGS. 7A to 9 illustrate a prop 30 to keep the luggage-compartment bonnet of a passenger vehicle open during painting or other manufacturing processes, by way of several drawings of the prop itself and also pictures of it in the installed state. FIG. 7A shows the actual bonnet prop 30 together with an extension rod 31, which comprises a handling ring 32 and two fixing hooks 33, 34, which are tilted in space with respect to one another and also differently shaped.

In FIG. 7B,C it is especially easy to identify the coiled (like a “pigtail”) end 35 of the bonnet prop 30 and the U-shaped cross-sectional configuration of its base structure 36, to allow insertion of the extension rod 31 (which is square in cross section). With its specially coiled end 35 the bonnet prop 30 can, to a certain extent, independently find a suitable fixation or catch point on the somewhat variably arranged straps 4 associated with the lock reinforcements 5 of the various luggage-compartment covers 6 of vehicles for which it is meant to be used. With the fixing hooks 33, 34 at the other end of the (elongated) bonnet prop 30, 31, the support is set upright on suitable engagement points in the interior of the engine compartment. In this embodiment, again, the processing means is suitable for handling by a robotic mechanism equipped with a suitable grasping tool.

The implementation of the invention is not restricted to the examples described above and the aspects emphasized here, but is also possible in a large number of modifications that are within the scope of those skilled in the art.

### List of Reference Numerals

1 Vehicle door

2 B-post

3 Interior metal plate in locking region of door

4 Strap

5 Lock reinforcement

6 Luggage-compartment cover

10 Door hook

11, 18 Arm

12 Connecting piece (bridge)

13 Spacer projection

14 Expansion (first catch section)

15 Hook-shaped end

16 Attachment plate

17 Middle part

19 Thickened end

19a Mounting peg

20 Cover hook

21 Basic body (rod)

22 Holder

23 Hook

24 Supporting flange

25 Thickening

26 Bore

27 Holding frame

27a, 27b Projections

27c Bridge

1. Processing means to hold part of a vehicle body during a processing operation in vehicle construction, in particular painting, comprising:
a plastic holder with two contact or engagement sections disposed near its ends, which are to be inserted between two body parts in order to fix them at a prespecified distance from one another.

2. Processing means according to claim 1, wherein a handling section is constructed for engaging a grasping tool operated by a robotic mechanism.

3. Processing means according to claim 1, wherein the plastic holder consists, at least to a substantial extent, of a highly thermally stable plastic that can be used in the long term at a temperature of at least 170° C.

4. Processing means according to claim 1,
wherein the plastic holder consists of glass-fibre-reinforced polyamide with a filler reinforcement in a proportion between 0.1% and 40%, in particular between 5% and 20%.

5. Processing means according to claim 1,
wherein the plastic holder consists to a substantial extent, in particular amounting to 50% or more and preferably to 70% or more, of recycled material.

6. Processing means according to claim 1,
wherein the contact or engagement sections have a prespecified elasticity of shape and material so that they can be inserted into specially provided apertures in the body parts without damaging their surfaces, and in particular are connected to one another by flexible extension arms or rod parts of a basic plastic structure.

7. Processing means according to claim 1,
further comprising construction as a door hook with a first engagement section to engage a metal plate in the interior of the locking region of a door and with a second engagement section to engage at least one retaining section, in particular apertures, on the basic vehicle body.

8. Processing means according to claim 7,
wherein the door hook comprises a clamp with two narrow arms connected to one another by a connecting piece in the central region, the first ends of which form the first engagement section and the second ends of which are connected to or hooked into a fixation plate that bears two projections designed to serve as the second engagement sections for engagement in openings on a B- or C-post of a passenger vehicle.

9. Processing means according to claim 1,
wherein construction as a bonnet prop with an engagement section, in particular one that is coiled, at its end to engage a bonnet-closing strap on an engine bonnet.

10. Processing means according to claim 9,
wherein the bonnet prop comprises a rod-shaped, in particular four- or six-sided basic structure with a hollow end, into which can be inserted an extension rod.

11. Bonnet prop according to claim 9,
further comprising a ring-shaped handling section, which in particular is moulded as part of the extension rod, and at least one erection hook positioned opposite the coiled engagement section, in particular being moulded as part of the extension rod.

12. Processing means according to claim 1,
further comprising construction as a cover hook with an engagement section, in particular one that is set at an angle and flattened, disposed at its end to engage a lock reinforcement of a luggage-compartment cover.

13. Processing means according to claim 12,
wherein the engagement section is attached at one end of a rod-shaped basic structure, the other end of which terminates in a holding ring in the same plane as the rod, and in the middle region of the rod-shaped basic structure an approximately rectangular strap is integrally formed, which likewise lies in the same plane as the basic structure and the holding ring at the end.

14. Processing means according to claim 13,
wherein between the angled engagement section and the rod-shaped basic structure of the cover hook a supporting flange is disposed.
